(19) United States
(12) Patent Application Publication
(10) Pub. No.: US 2006/0238280 A1
(43) Pub. Date: Oct. 26, 2006

(54) Magnetic springs for asset containers

(75) Inventors: Agjah I. Libohova, Bayside, NY (US); Timothy J. Keuning, Northport, NY (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: AUTRONIC PLASTICS, INC, Westbury, NY (US)

(21) Appl. No.: 11/471,102

(22) Filed: Jun. 19, 2006

Related U.S. Application Data
(63) Continuation-in-part of application No. 11/409,168, filed on Apr. 21, 2006.
(60) Provisional application No. 60/674,362, filed on Apr. 22, 2005.
(60) Provisional application No. 60/691,598, filed on Jun. 17, 2005.

(51) Int. Cl. H01H 9/00

(52) U.S. Cl. 335/179

(57) ABSTRACT

A magnetic spring is provided that includes a first magnetic assembly with a first plunger and a second magnetic assembly with a second plunger. The first and second magnetic assemblies are disposed within a housing structure in repulsion. The distance between the first and second magnetic assemblies may be decreased by applying a force to at least one of the first and second actuating portions. The magnetic spring may form at least a portion of a hub portion of an asset container. The hub portion may be used as part of a benefit-denial device releasably securing an asset to the asset container.

### CROSS-REFERENCE TO RELATED APPLICATIONS

This application is a continuation-in-part of U.S. patent application Ser. No. 11/409,168, filed Apr. 21, 2006, which claims the benefit of Provisional Patent Application No. 60/674,362, filed Apr. 22, 2005. This application also claims the benefit of Provisional Patent Application No. 60/691,598, filed Jun. 17, 2005. All the aforementioned earlier-filed applications are hereby incorporated by reference herein in their entireties.

### BACKGROUND OF THE INVENTION

The present invention relates generally to magnetic springs, and, more particularly, to a configuration of magnets for use in asset containers that is capable of producing a spring effect when acted upon by, for example, a physical or magnetic force.

Currently, there are many containers that can be used to secure storage media such as, for example digital versatile discs (DVDs), compact discs (CDs), video games, other data storage media, and other consumer products. A typical storage container includes a cover portion and a base portion that is hingedly coupled to the cover portion. An item to be secured is placed in the container, and the cover portion is mated with the base portion to secure the item within the container. The storage containers may, for example, be displayed in a live retail or rental environment, where potential customers can handle and examine the storage container to determine whether to buy or rent the item. However, in a live retail or rental environment, it is often desirable to provide a simple locking mechanism to deter theft of an asset within an asset container.

Currently, various locking approaches exist for use in asset containers in both the live retail and rental environments. One approach for locking a storage container involves placing an active electronic security tag (e.g., electronic article surveillance (EAS) tag) on the container. Another approach involves providing a locking member that is configured to engage a series of tabs in a locking channel composed of both the front and back covers of the container.

The approaches described above, however, have some limitations. For example, external tags and apparatus are easily susceptible to breach because they are exposed. The containers with such tags and apparatus are often locked behind a sales or rental counter for additional security, which denies a consumer the benefit of a live sale. Moreover, the external apparatus and locking members are typically cumbersome and difficult to operate. In addition, they are typically removed from the asset container and discarded, which is not environmentally friendly, or recycled, which may require the consumption of retail or rental establishment resources.

Accordingly, it would be desirable to provide a simple magnetic spring mechanism that may be disposed in asset containers. The magnetic spring apparatus may form part of a hub portion of the asset container and may permit locking and unlocking of an asset within the asset container. It is further desirable to provide a simple magnetic spring apparatus for use in any application requiring a repulsive spring force.

### SUMMARY OF THE INVENTION

These and other objects of the invention are accomplished in accordance with the principles of the present invention by providing a magnetic spring for use in releasably securing a removable asset to an asset container. The magnetic spring includes a first magnetic assembly with a first plunger and a second magnetic assembly with a second plunger. The first and second magnetic assemblies have first and second actuating portions. The first and second magnetic assemblies are disposed within a housing structure in repulsion. The distance between the first and second magnetic assemblies may be decreased by applying a force to at least one if the first and second actuating portions.

In some embodiments, a magnetic spring is provided including a magnetic assembly with a first magnet and a plunger. A second magnet and the first magnet are disposed within a housing structure in repulsion. The housing structure may have a first end portion and, a second end portion. The magnetic assembly is free to move within the housing structure, while the second magnet is affixed to the second end portion of the housing structure.

In some embodiments, the housing structure of a magnetic spring forms at least part of the hub portion of an asset container. At least one ball bearing may reside around the periphery of the housing structure. In a locked configuration, an asset may be held within the asset container by the ball bearings, which are prevented from moving toward the center of the housing structure by one or more plungers. By reversing the polarity of the second magnet or using an external decoupler, the two magnets may be put in attraction, resulting in the plunger moving downward with the first magnet toward the second magnet. The at least one ball bearing is now free to move toward the center of the housing structure, and the asset may be freely removed from the container.

### BRIEF DESCRIPTION OF THE DRAWINGS

The above and other features of the present invention, its nature and various advantages will be more apparent upon consideration of the following detailed description, taken in conjunction with the accompanying drawings, in which:

FIG. 1 is an exploded perspective view of an illustrative magnetic spring in accordance with one embodiment of the present invention;

FIG. 2 is a perspective view of outer housing portions engaging inner housing portions in accordance with one embodiment of the present invention;

FIG. 3 is a perspective view of a magnetic spring as used in an asset container in accordance with one embodiment of the invention;

FIG. 4 shows the asset container of FIG. 3 with a disc placed around a center hub portion in accordance with one embodiment of the invention;

FIG. 5 shows the asset container of FIG. 4 with a locking clip inserted into the container to engage portions of the outer housing of the magnetic spring in accordance with one embodiment of the invention;

FIG. 6 is a perspective view of an illustrative decoupler that may be used to decouple the locking clip of FIG. 5 from the magnetic spring in accordance with one embodiment of the invention;

FIGS. 7 and 8 show two different perspective views of an asset container inserted into a channel of the decoupler of FIG. 6 in accordance with one embodiment of the invention;

FIG. 9 is a side sectional view of FIG. 8 in accordance with one embodiment of the invention;

FIG. 10 is an enlarged view of FIG. 9, showing in detail the interaction between the decoupler and the magnetic spring in accordance with one embodiment of the invention;

FIG. 11 is a magnified view of FIG. 10 showing the interaction between the decoupler and the magnetic spring in more detail in accordance with one embodiment of the invention; and

FIGS. 12 and 13 are simplified sectional views of another illustrative magnetic spring in accordance with another embodiment of the present invention.

### DETAILED DESCRIPTION OF THE PREFERRED EMBODIMENTS

The present invention provides various embodiments of magnetic springs which may be used, for example, in the hub portions of lockable asset containers. Although the described embodiments are generally directed to two magnets in repulsion, any number of magnets may be used in alternate embodiments.

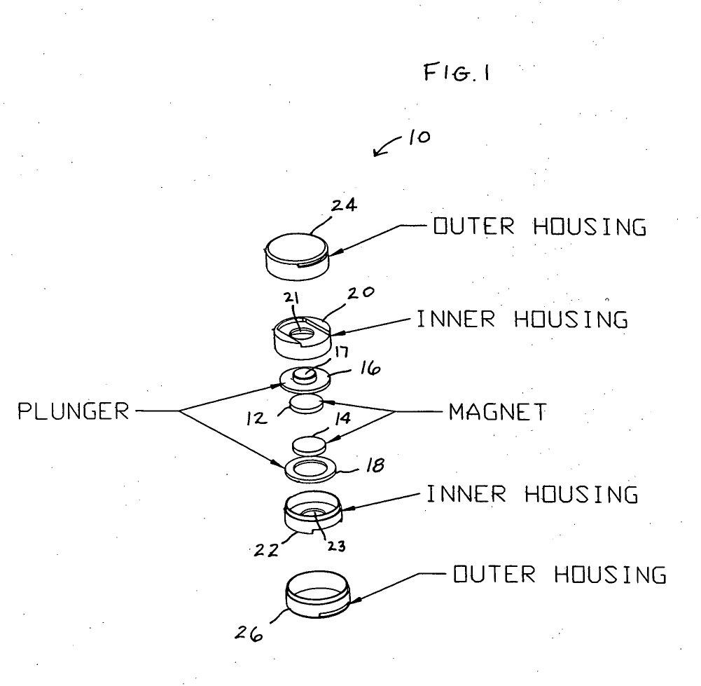

FIG. 1 is an exploded perspective view of an illustrative magnetic spring 10 in accordance with the present invention. As shown in FIG. 1, magnetic spring 10 may include first magnet 12 and second magnet 14. First and second magnets 12 and 14 may be aligned such that the two magnets are in repulsion, thereby creating a spring effect between the two magnets.

Magnetic spring 10 may include first and second plungers 16 and 18. In one embodiment, first magnet 12 and first plunger 16 may be formed as a unitary magnetic body, and second magnet 14 and second plunger 18 may be formed as another unitary magnetic body. In another embodiment, first and second plungers 16 and 18 may be constructed of a material such as, for example, a plastic, such that first and second magnets 12 and 14 are attached to their respective plungers. For example, a snap fit may exist between the magnets and the plungers, an adhesive may be applied between the magnets and the plungers, or any other suitable manner of attaching the magnets to the plungers may be used. In yet another example, first and second plungers 16 and 18 may be constructed of a material such as, for example, a metal, such that first and second magnets 12 and 14 are magnetically affixed to their respective plungers.

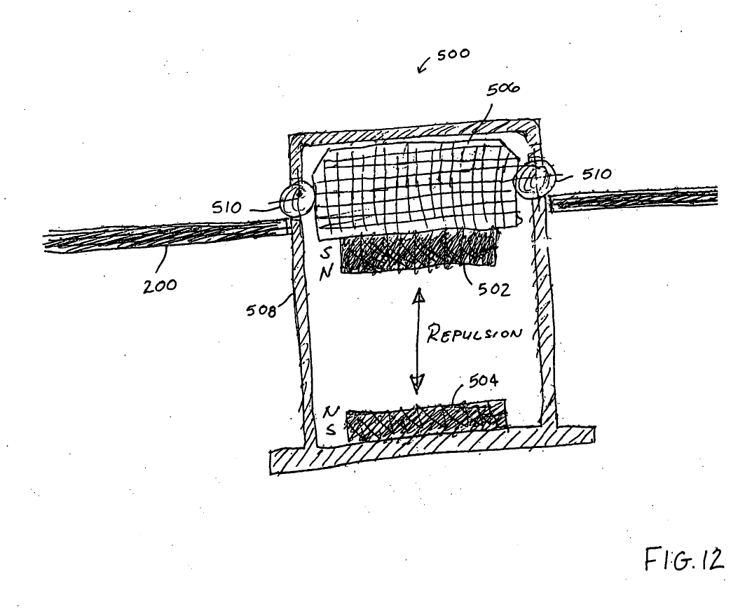

Magnetic spring 10 may include inner housing portions 20 and 22. Inner housing portions 20 and 22 house the assembly of first magnet 12 and first plunger 16, and the assembly of second magnet 14 and second plunger 18, respectively. Inner housing portions 20 and 22 engage one another, forming a container that maintains alignment between the first and second magnet and plunger assemblies. Inner housing portions 20 and 22 may include respective openings 21 and 23, within which actuating portions 17 and 19 of first and second plungers 16 and 18 may reside (actuating portion 19 of second plunger 18 is shown in FIG. 11). The interaction between actuating portions 17 and 19 and openings 21 and 23 is shown in more detail in FIG. 11, below. Inner housing portions 20 and 22 are constructed of a non-magnetic material.

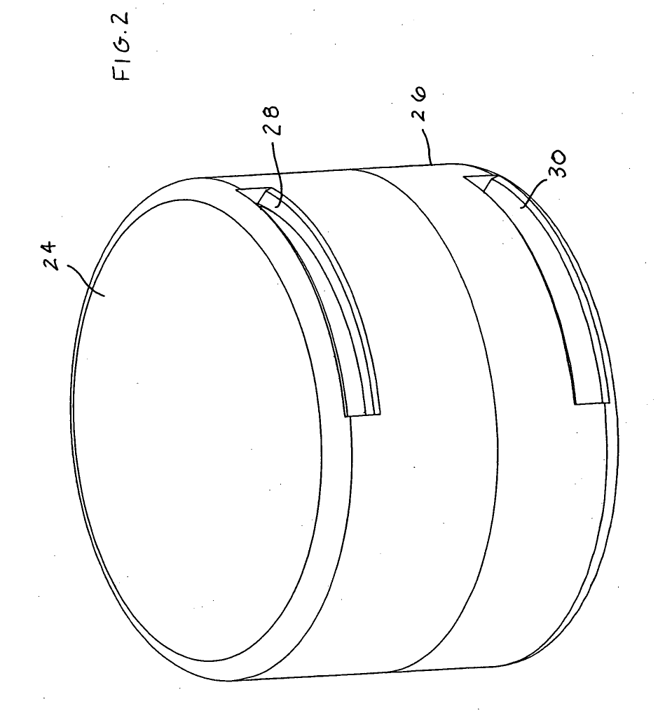

As stated hereinabove, inner housing portions 20 and 22 engage one another, forming a container that aligns the first and second magnet and plunger assemblies. Because magnets 12 and 14 are in repulsion, but are maintained in alignment by inner housing portions 20 and 22, a “spring” is formed between the magnets. This is referred to herein as a “magnetic spring.” Magnetic spring 10 may be compressed by a force (i.e., magnets 12 and 14 may be forced toward one another, thereby decreasing the distance between them), such as a physical force or a magnetic force. For example, a physical force may be applied to actuating portions 17 and 19 of plungers 16 and 18, respectively, thereby compressing magnetic spring 10. In another example, a magnetic force may be applied to the plunger/magnet assemblies of magnetic spring 10 by aligning actuating magnets with each of the plunger/magnet assemblies, such that the actuating magnets are in repulsion with the magnets of the plunger/magnet assemblies. The repulsion between the actuating magnets and the plunger/magnet assemblies creates a magnetic force that forces magnets 12 and 14 toward one another. One embodiment of the magnetic spring in connection with an asset container is shown in FIGS. 2-11 and is described hereinbelow. It should be noted that, to decrease the distance between magnets 12 and 14, the force (e.g., physical, magnetic, etc.) applied to the plunger/magnet assemblies must be greater than the repulsive force between the magnets.

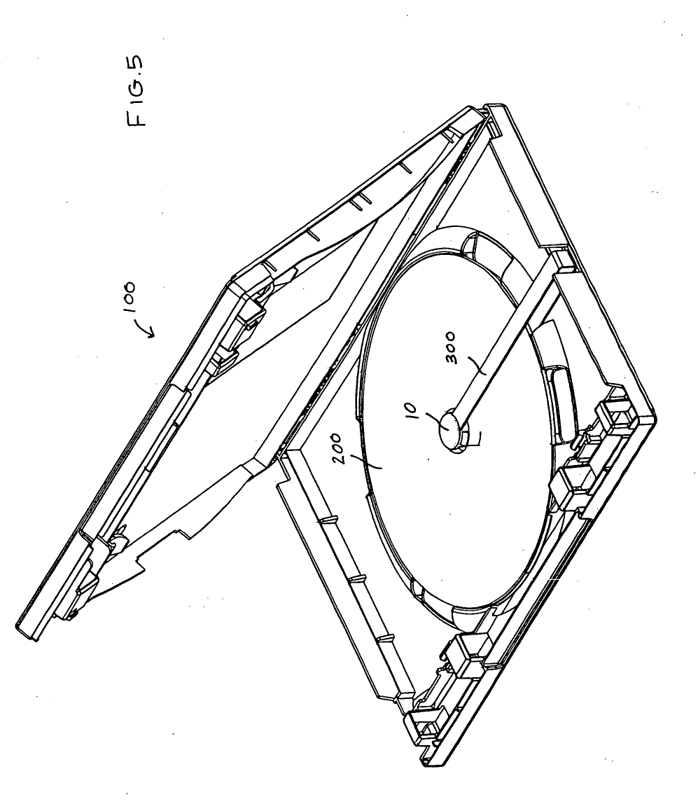

In some embodiments of the present invention, as shown in FIG. 1, magnetic spring 10 may include outer housing portions 24 and 26 that engage one another to contain inner housing portions 20 and 22, plungers 16 and 18, and magnets 12 and 14. Outer housing portions 24 and 26 may be included, for example, in embodiments of the magnetic spring of the present invention that are used in asset containers (e.g., asset container for storage media). For example, magnetic spring 10 may be used along with a locking clip (see, for example, locking clip 300 of FIG. 5) to trap a disc such as a digital versatile disc (DVD), a compact disc (CD), or a video game. This may be referred to as a “benefit denial” device, in that the trapped disc is rendered unusable by the magnetic spring/locking clip assembly.

FIG. 2 is a perspective view of an assembly of outer housing portions 24 and 26, engaging one another to contain inner housing portions 20 and 22, plungers 16 and 18, and magnets 12 and 14. Outer housing portions 24 and 26 include slots 28 and 30, respectively, for receiving locking clip 300 (FIG. 5). Outer housing portions 24 and 26 prevent access to the magnetic spring contained within the housing. In one embodiment, outer housing portions 24 may be constructed of a non-magnetic material, such as steel, for increased tamper resistance.

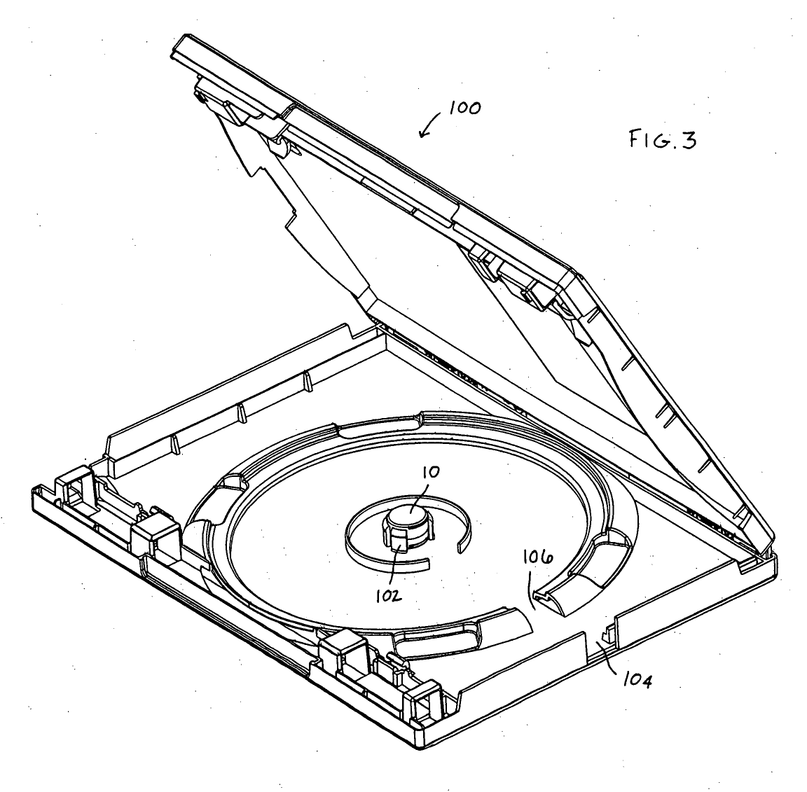

FIG. 3 is a perspective view of magnetic spring 10 as used in asset container 100 for storage media. In particular, magnetic spring 10 is inserted into hub portion 102 of container 100. Container 100 may be any suitable container for securing storage media such as, for example, the containers described in Lax et al. U.S. Patent Publication No. 2002/0023853, published Feb. 28, 2002, Lax et al. U.S. Patent Publication No. 2006/0042330, published Mar. 2, 2006, both of which are hereby incorporated by reference herein in their entireties. Container 100 may include cut-out portions 104 and 106, which may be used to guide locking clip 300 into engagement with magnetic spring 100 (as shown in FIG. 5, below).

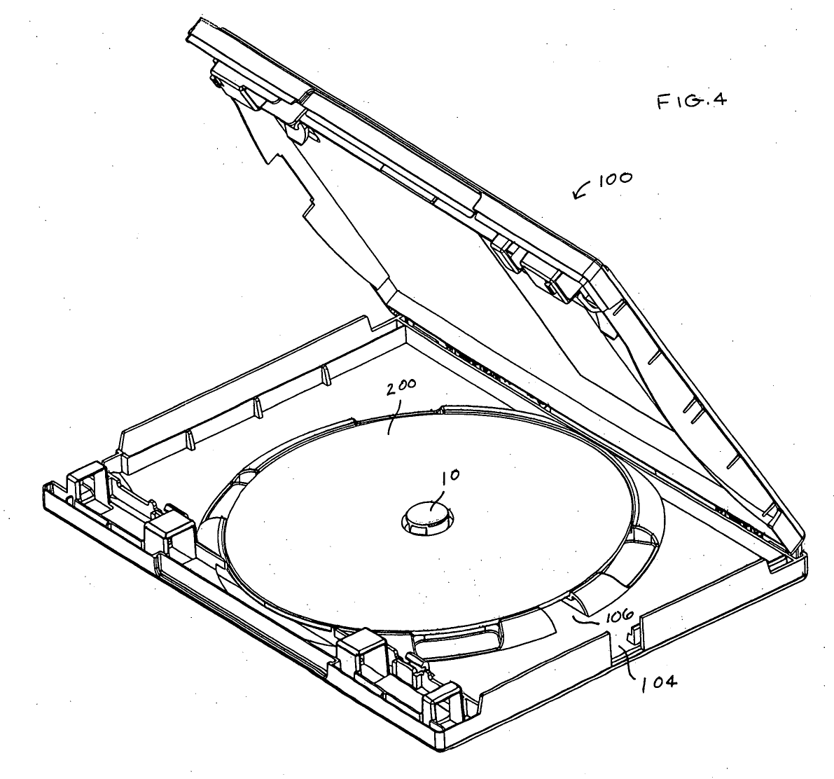

As shown in FIG. 4, a disc 200 may be placed upon-hub portion 102. As shown in FIG. 5, locking clip 300 may be inserted into container 100 such that the free ends of the locking clip enter slots 28 and 30 of outer housing portions 24 and 26. Within outer housing portions 24 and 26, the free ends of locking clip 300 may slide over actuating portions 17 and 19 of plungers 16 and 18, until the actuating portions engage respective undercut portions of the free ends (see FIG. 11 for more detail). In some embodiments, the free ends of locking clip 300 and actuating portions 17 and 19 of plungers 16 and 18 may be chamfered such that the free ends slide over the actuating portions with less obstruction.

In some embodiments of the present invention, the free end portions of locking clip 300 may be coated to prevent scratching disc 200 when the clip is inserted and/or removed from container 100.

The interaction of magnetic spring 10 and locking clip 300 traps disc 200 within container 100. In particular, the engagement of actuating portions 17 and 19 with respective undercut portions of the free ends of locking clip 300 (see FIG. 11) prevents the locking clip from being removed from the container by, for example, a thief.

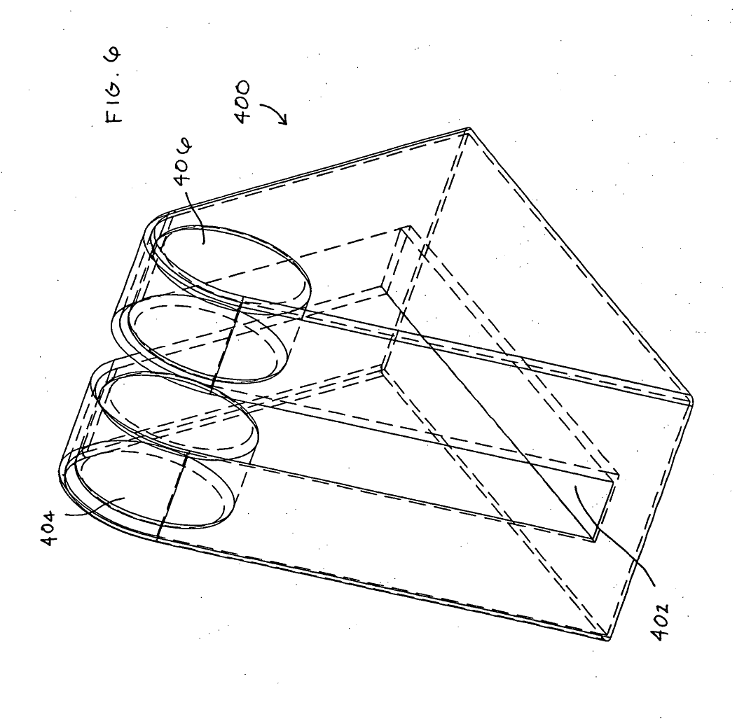

FIG. 6 is a perspective view of an illustrative decoupler 400 that may be used to decouple locking clip 300 from magnetic spring 10 in accordance with the present invention. As shown, decoupler 400 includes a channel 402 for receiving container 100 and first and second magnets 404 and 406.

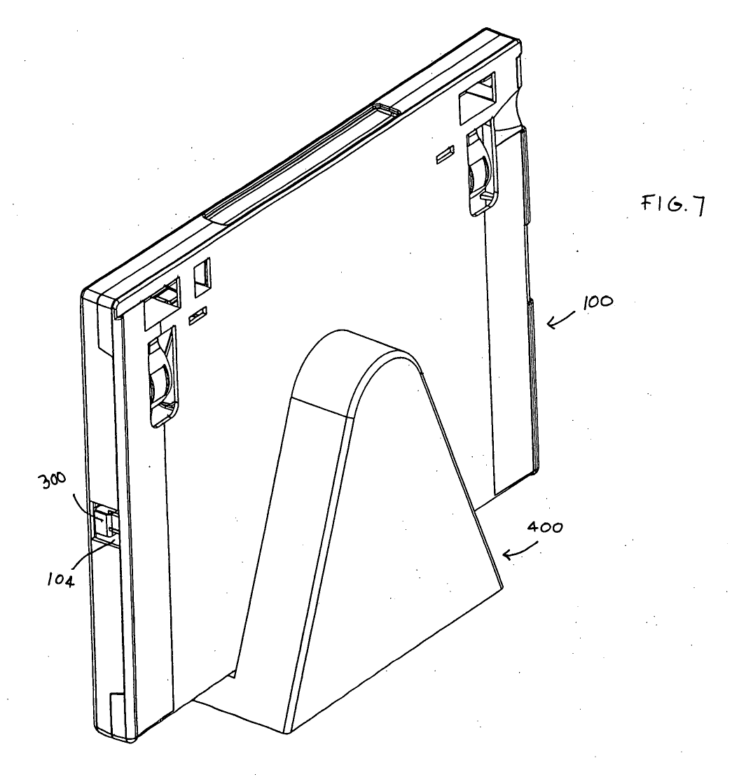

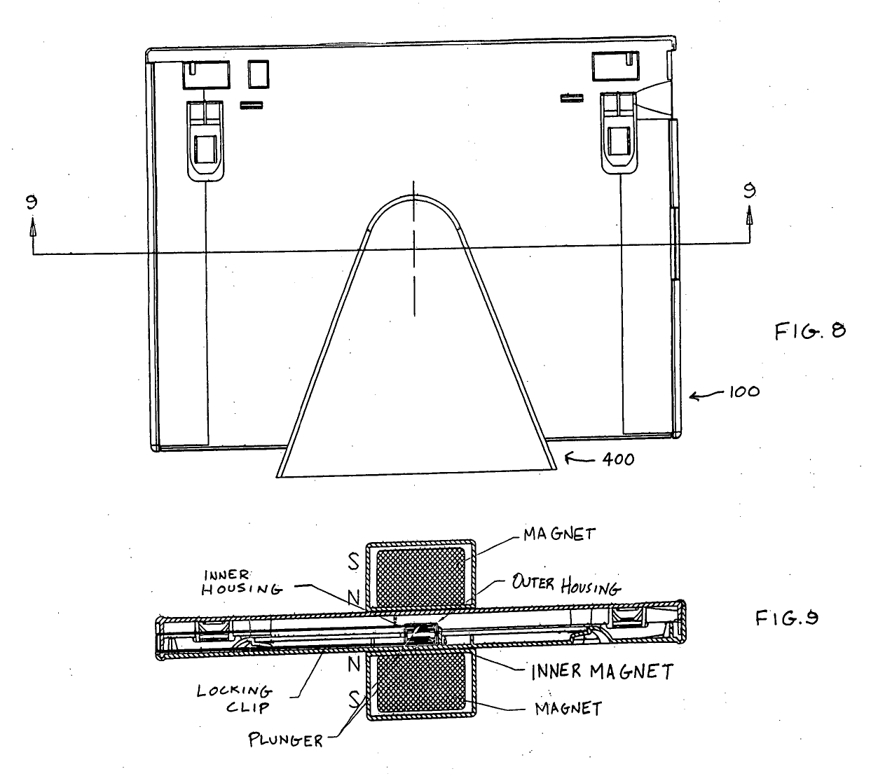

FIGS. 7 and 8 show two different perspective views of container 100 as inserted into channel 402 of decoupler 400. Container 100 may be inserted into channel 402 such that magnets 404 and 406 are aligned with magnets 12 and 14, respectively, of magnetic spring 10. As shown in FIG. 9, which is a side sectional view taken along line 9-9 of FIG. 8, decoupler 400 is constructed such that magnets 404 and 406 are in repulsion with magnets 12 and 14 when container 100 is inserted into channel 402.

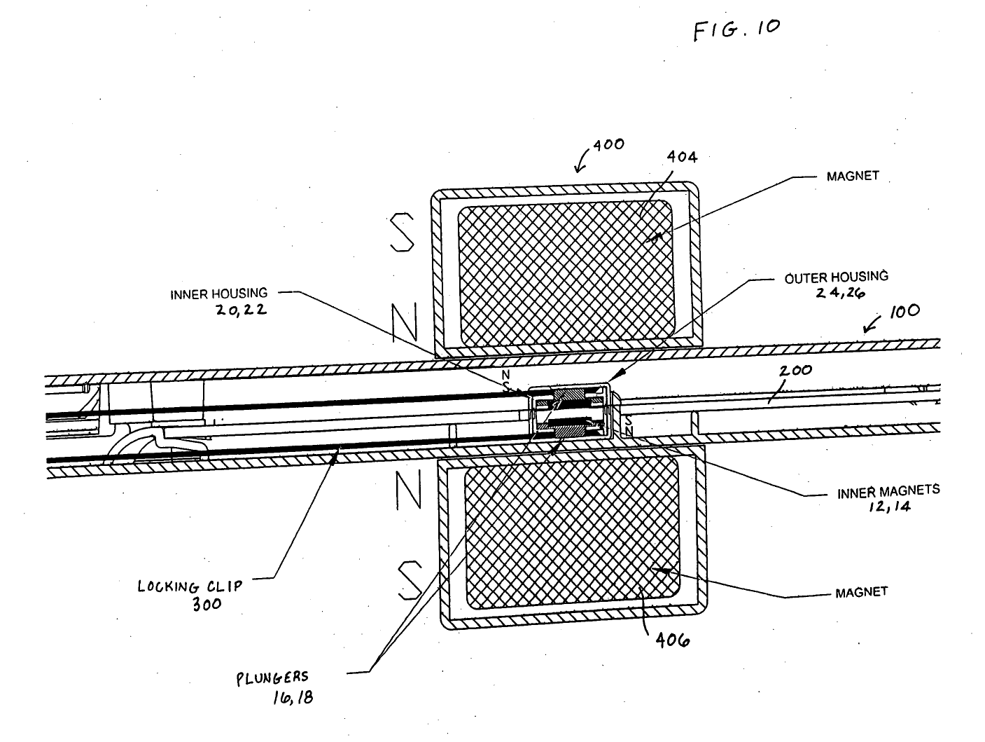

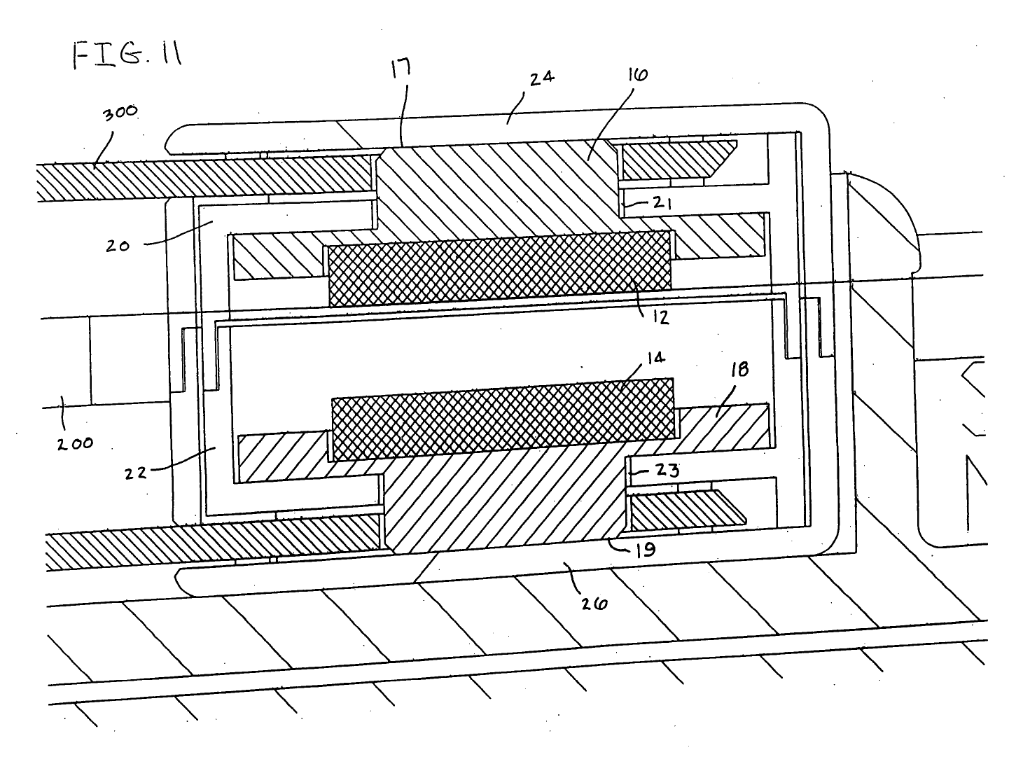

FIG. 10 is an enlarged view of FIG. 9, showing in detail the interaction between decoupler 400 and magnetic spring 10. As shown, magnet 404 is in repulsion with magnet 12, and magnet 406 is in repulsion with magnet 14. These repulsive magnetic forces result in a decrease of the distance between magnets 12 and 14. In other words, magnetic spring 10 is compressed by the repulsive forces between magnets 404 and 12, and magnets 406 and 14. When magnetic spring 10 is compressed, actuating portions 17 and 19 of plungers 16 and 18 are no longer trapped within the undercuts of the free end portions of locking clip 300 (see FIG. 11), such that locking clip 300 is free to be removed from container 100. Locking clip 300 may be removed by pulling on the portion of the clip that is exposed by opening 104 of container 100 (see FIG. 7). Locking clip 300 may be removed, for example, by an employee of a retail or rental establishment after container 100 has been purchased or rented by a customer.

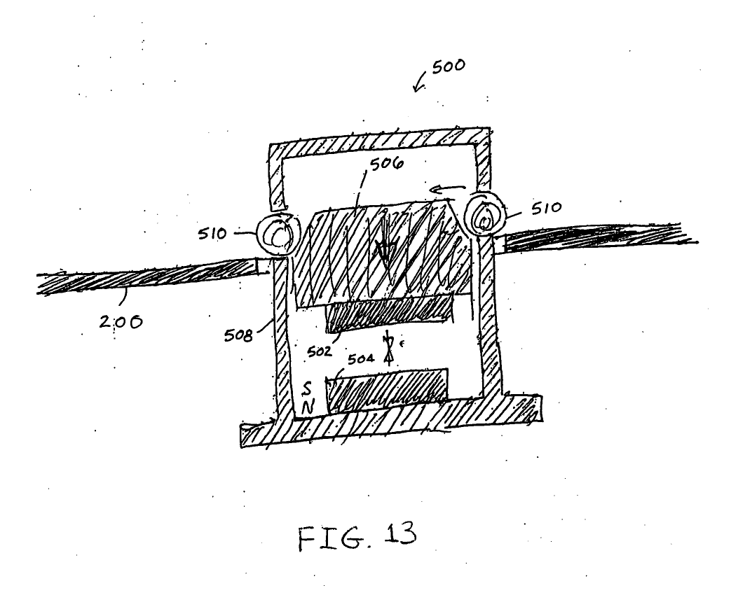

FIGS. 12 and 13 are simplified sectional views of another illustrative magnetic spring 500 in accordance with the present invention. Magnetic spring 500 may be used to trap disc 200 within an asset container. As shown in FIGS. 12 and 13, magnetic spring 500 may form the hub structure of the container. Alternatively, magnetic spring 500 may be inserted into an existing hub structure of a container (for example, hub portion 102 of container 100, as shown in FIG. 3).

Magnetic spring 500 may include a first magnet 502 and a second magnet 504 as housed within a housing structure 508. As described hereinabove, in some embodiments housing structure 508 may form the hub structure of the container within which magnetic spring 500 is used. Magnet 504 may be affixed to housing structure 508 (e.g., with adhesive). Magnetic spring 500 may include a plunger 506. In one example, first magnet 502 and plunger 506 may be formed as a unitary magnetic body. In another example, plunger 506 may be constructed of a material such as, for example, a plastic, such that first magnet 502 is attached to the plunger. For example, a snap fit may exist between first magnet 502 and plunger 506, an adhesive may be applied between the magnet and the plunger, or any other suitable manner of attaching the magnet to the plunger. In yet another example, plunger 506 may be constructed of a material such as, for example, a metal, such that first magnet 502 is magnetically affixed to the plunger.

Magnetic spring 500 may include multiple ball bearings 510 residing around the periphery of housing structure 508 within respective openings in the housing structure. In some embodiments, magnetic spring 500 may include four or more ball bearings 510. However, this example is merely illustrative, and magnetic spring 500 may include any suitable number of ball bearings 510.

FIG. 12 shows magnetic spring 500 in a locked configuration. In other words, disc 200 is locked within the container by magnetic spring 500. As shown, magnets 502 and 504 are in repulsion such that plunger 506 prevents ball bearings 510 from moving toward the center of housing structure 508. In such a configuration, ball bearings 510 prevent the removal of disc 200 from the container.

FIG. 13 shows magnetic spring 500 in an unlocked configuration. In other words, disc 200 may be removed from the container, if desired. In one embodiment, magnetic spring 500 may attain the unlocked configuration by reversing the polarity of second magnet 504 such that first and second magnets 502 and 504 are in attraction. The attraction between first and second magnets 502 and 504 results in plunger 506 moving downward with first magnet 502 toward second magnet 504, thereby allowing ball bearings 510 to move toward the center of housing structure 508. This allows disc 200 to slide freely over ball bearings 510 and be removed from the container.

Additionally or alternatively, magnetic spring 500 may attain the unlocked configuration as shown in FIG. 13 by using a decoupler (not shown) similar to decoupler 400 of FIG. 6. For example, the container may be inserted into a decoupler having only one actuating magnet such that the actuating magnet of the decoupler is in repulsion with first magnet 502 of the magnetic spring. The repulsion between the actuating magnet and first magnet 502 results in the movement of first magnet 502 toward second magnet 504, thereby allowing ball bearings 510 to move toward the center of housing structure 508.

The above described embodiments of the present invention are presented for purposes of illustration and not of limitation, and the present invention is limited only by the claims which follow.

What is claimed is:

1. A magnetic spring, comprising:
a first magnetic assembly comprising a first magnet and a first plunger, the first plunger having a first actuating portion;
a second magnetic assembly comprising a second magnet and a second plunger, the second plunger having a second actuating portion; and
a housing structure having first and second end portions, the first and second magnets being disposed within the housing structure in repulsion, the first actuating portion extending through an opening in the first end portion and the second actuating portion extending through an opening in the second end portion, wherein a distance between the first and second magnets is decreased by applying a force to at least one of the first and second actuating portions.

2. The magnetic spring of claim 1 wherein the housing structure aligns the first magnet with the second magnet.

3. The magnetic spring of claim 1 wherein the first magnet and the first plunger are formed as a first unitary magnetic body, and the second magnet and the second plunger are formed as a second unitary magnetic body.

4. The magnetic spring of claim 1 wherein at least one of the first plunger and the second plunger are composed of plastic.

5. The magnetic spring of claim 4 wherein at least one of the first magnet and the second magnet attaches to at least one of the first plunger and the second plunger in a snap fit relationship.

6. The magnetic spring of claim 4 wherein the first magnet is attached to the first plunger with adhesive and the second magnet is attached to the second plunger with adhesive.

7. The magnetic spring of claim 1 wherein the first actuating portion is concentric with the first magnet and the second actuating portion is concentric with the second magnet.

8. An asset container comprising the magnetic spring of claim 1.

9. The asset container of claim 8 wherein the housing structure of the magnetic spring forms at least part of a hub portion of the asset container.

10. A magnetic spring, comprising:
a magnetic assembly comprising a first magnet and a plunger;
a second magnet; and
a housing structure having first and second end portions, the first and second magnets being disposed within the housing structure in repulsion, the magnetic assembly being free to move within the housing structure, and the second magnet being affixed to the second end portion.

11. The magnetic spring of claim 10 wherein the housing structure aligns the first magnet with the second magnet.

12. The magnetic spring of claim 10 wherein the first magnet and the plunger are formed as a first unitary magnetic body.

13. The magnetic spring of claim 10 wherein the plunger is composed of plastic.

14. The magnetic spring of claim 13 wherein the first magnet attaches to the plunger in a snap fit relationship.

15. The magnetic spring of claim 13 wherein the first magnet is attached to the plunger with adhesive.

16. The magnetic spring of claim 10 further comprising at least one ball bearing disposed around the periphery of the housing structure.

17. The magnetic spring of claim 16 wherein the plunger prevents the at least one ball bearing from moving toward the center of the housing structure.

18. An asset container comprising the magnetic spring of claim 17.

19. The asset container of claim 18 wherein the housing structure of the magnetic spring forms at least part of a hub portion of the asset container.

20. The asset container of claim 19 wherein the hub portion releasably secures a disc to the asset container.
